(19) United States
(12) Patent Application Publication
(10) Pub. No.: US 2026/0193913 A1
(43) Pub. Date: Jul. 9, 2026

(54) HOOK AND RIVET PIN WINDOW OPEN CONTROL DEVICE

(71) Applicant: ROTO-FRANK OF AMERICA, INC., Chester, CT (US)

(72) Inventors: Suban ARIARATNAM, Toronto (CA); Jason SORRENTINO, Haddam, CT (US); Robert CHRISTIE, South Glastonbury, CT (US); Christopher GRIFFIN, Groton, CT (US)

(21) Appl. No.: 19/445,148

(22) Filed: Jan. 9, 2026

Related U.S. Application Data
(60) Provisional application No. 63/743,501, filed on Jan. 9, 2025.

(51) Int. Cl. E05C 17/14

(52) U.S. Cl. CPC E05C 17/14

(57) ABSTRACT

A casement window and awning window opening control device for limiting the opening of a window having a hook arm assembly with a hook lock slidably mounted over a portion of a hook arm to restrict ingress and egress of a rivet pin into a receiving hook and rivet pin assembly having a pivot arm biased to a desired position so that when the window is opened the rivet pin is biased towards the frame away from the sash to ensure proper re-engagement of the receiving hook and rivet pin when the sash is opened, enhancing efficiency and ensuring safety.

### CLAIM TO PRIORITY AND INCORPORATION BY REFERENCE

This application claims priority to U.S. Provisional Patent Application 63/743,501 titled “Hook and Rivet Pin Window Open Control Device,” filed on January 9, 2025, the contents of which are incorporated here by reference.

### BACKGROUND

Casement windows and awning windows, though similar in their basic hinged construction, differ because of the positioning of their hinges. Both types of windows are composed of a single sash, which is a framed part of the window that holds the glass in place and can be moved for opening and closing. The sash is attached to the window frame through a hinge and can be cranked open or shut. A casement window's hinge is usually situated either on the left or right side. This design allows the window to open outwards like a door, offering a wide and unobstructed view of the outdoors. Because they crank open rather than slide, casement windows are often chosen for their ability to provide superior ventilation. They are also popular for their ease of operation, making them an excellent choice for hard-to-reach areas. On the other hand, an awning window is essentially a casement window turned on its side. The hinge is generally located at the top, which allows the window to swing outward from the bottom. This design makes awning windows uniquely suited for letting in fresh air, even during inclement weather, as the open sash creates a sort of awning that prevents rain or snow from entering the house.

In both casement windows and awning windows (hereinafter, collectively, "casement windows"), the window's outer structure, the frame, is constructed from materials such as wood, vinyl, aluminum, or fiberglass, and provides the necessary structural support when installed in the wall. Within this frame, the sash is usually made from the same material as the frame and is equipped with weatherstripping along its edges to ensure a tight seal, which helps prevent drafts and enhances energy efficiency. The window operates smoothly through a crank handle or lever mechanism, generally located adjacent the hinged side, which controls the gear mechanism that opens or closes the window. The hinges are designed to support the weight of the window and allow for wide openings, providing excellent ventilation and easy cleaning access. The window is secured by a locking mechanism, often a multipoint lock that engages at several points along the sash and frame, ensuring the window is tightly closed and secure. The combination of functional design, energy efficiency, and customizable aesthetics makes casement windows a popular choice in both residential and commercial architecture. This is because the designs are easy to maintain, as the wide opening provides easier access to outside surfaces for maintenance and cleaning. Nonetheless, there are several problems and safety issues that must be addressed to ensure casement windows operate effectively and safely.

One of the primary issues with casement windows is the potential for mechanical failure in the hinges, cranks, or locking mechanisms. Over time, these components wear out, leading to difficulty in opening or closing the window. If the hinges become loose or damaged, the sash may not align properly with the frame causing the window to stick or fail to close completely.

Another significant concern is the potential for injury due to the window's outward-opening design. Because casement windows open outward, there is the potential for them to open beyond a safe or desired distance, particularly in multistory buildings where falling hazards may exist. For example, some casement windows can be opened wide enough that a person or animal fits through the opening.

To address these concern, various window opening control devices (WOCDs) have been developed, typically involving limiting arms or similar mechanisms to restrict the degree of window opening. Indeed, the Consumer Product Safety Commission (CSPC) has advised caregivers to open windows less than 4 inches when children are present as one means to prevent children from falling through open windows. WOCDs provide a means that the window, when opened in an initial operation, will satisfy the CPSC recommendation to open less than 4 inches. The 4 inch dimension is drawn from related building codes and standards for openings in guardrail assemblies and is universally accepted as the appropriate dimension to prevent a child from passing through balcony or guard railing systems.

On the other hand, there is the issue of emergency egress. In certain situations, such as a fire, a casement window may be the only available exit. If the window is difficult to open due to mechanical failure, or the WOCD mechanism is complex or hard to reach, it could delay or prevent a person from escaping, creating a serious safety risk. Accordingly, there must be a method to open the window beyond the WOCDs limit. This additional operation must be performed without the use of keys, tools, or special knowledge and be child resistant.

To address these challenges, there is a need for a simplified and reliable WOCD mechanism that allows for controlled opening a desired distance, a reliable, easy way to release the control mechanism, and automatic reengagement after release.

### SUMMARY

In view of the above, examples of window opening control devices for limiting the rotation of a sash movably mounted with a frame are described below. In one example, a window opening control device comprises a hook arm assembly for coupling to one of the frame or the sash, a rivet pin assembly for coupling to the other of the frame or the sash, the hook arm assembly including a base bracket, a first spindle projecting from a front face of the base bracket, and a hook arm having a first end and a second end, the first end being pivotally attached to the first spindle and the second end having a receiving hook, a hook lock slidably mounted to the second end of the hook arm, the hook lock biased away from the first spindle as the window is opened, and the rivet pin assembly including a mounting plate having a second spindle projecting from a front face of the mounting plate, and a pivot arm pivotally attached to the second spindle, the pivot arm having a rivet pin attached to a first end. This configuration provides a reliable window opening control mechanism that automatically limits window opening to a safe distance while maintaining the ability for emergency egress through a deliberate two-step release process.

According to one example, the hook arm is biased by a hook arm spring such that when the window is opened, the second end of the hook arm is biased towards the window opening. This spring biasing ensures automatic engagement of the control mechanism when the window is opened, providing consistent safety protection without requiring user intervention. The hook arm spring may include torsion, compression and extension springs.

According to another example, the hook arm is biased by stretchable return members, such as for example, plastic shims, o-rings, or elastic bands configured to bias the hook arm towards the open window, such that when the window is opened, the second end of the hook arm is biased towards the window opening.

According to another example, the hook arm is biased by opposing or attracting magnets such that when the window is opened, the second end of the hook arm is biased towards the window opening.

According to another example, the base bracket includes a limiting pin that engages in cutouts on the first end of the hook arm to prevent the hook arm from rotating beyond desired limits. This mechanical stop feature prevents over-rotation of the hook arm, ensuring proper alignment and engagement with the rivet pin assembly.

According to another example, the hook lock is shaped to engage the rivet pin when the hook arm is under tension relative to the rivet pin. This engagement mechanism secures the connection between the hook arm and rivet pin, preventing accidental disengagement during normal window operation.

According to another example, the hook lock is biased towards the first spindle by a hook lock spring as the hook lock is pulled away from the first spindle. This spring mechanism ensures the hook lock automatically returns to its locking position after engagement, providing reliable securing of the rivet pin connection.

According to another example, the hook lock is biased towards the first spindle by one or more elastic bands as the hook lock is pulled away from the first spindle. This elastic mechanism ensures the hook lock automatically returns to its locking position after engagement, providing reliable securing of the rivet pin connection.

According to another example, the receiving hook is shaped to have a curved or angled receiving section that securely latches onto the rivet pin when the window is opened. This specialized hook geometry ensures reliable capture and retention of the rivet pin, preventing slippage or accidental release.

According to another example, the mounting plate includes a rail positioned on the mounting plate opposite the window opening side of the mounting plate. This rail provides a sliding surface for the hook lock, enabling smooth operation and proper alignment during engagement and disengagement cycles.

According to another example, the pivot arm is biased by a pivot arm spring such that when the window is opened, the first end of the pivot arm is biased to rotate away from the rail. This biasing action positions the rivet pin at the optimal distance from the sash to facilitate reliable engagement with the receiving hook.

According to another example, the pivot arm is biased by stretchable return members, such as for example, plastic shims, o-rings, or elastic bands configured to rotate the first end of the pivot arm away from the rail.

According to another example, the pivot arm is biased by opposing or attracting magnets such that when the window is opened, the first end of the pivot arm is biased away the rail.

According to another example, the pivot arm includes a second end configured to contact the rail to prevent rotation of the first end beyond a desired distance such that the rivet pin is positioned at a desirable distance from the sash. This mechanical stop ensures consistent positioning of the rivet pin for reliable engagement while preventing over-rotation of the pivot arm.

According to another example, the rivet pin is cylindrical and made from a material selected from the group consisting of metal, plastic, and other durable materials capable of withstanding repeated use and environmental exposure. This material selection ensures long-term durability and reliable performance under various environmental conditions.

According to another example, the hook arm assembly and rivet pin assembly are configured such that disengagement requires two manual actions: sliding the hook lock distally away from the first spindle and pivoting the hook arm away from the rivet pin. This two-step release mechanism provides child-resistant operation while allowing adults to override the safety mechanism for emergency egress.

A window assembly is described below, the window assembly comprising a window frame, a sash pivotally mounted to the frame via one or more hinge mechanisms configured to enable a window opening, a hook arm assembly coupled to either the frame or the sash, a rivet pin assembly coupled to the other of the frame or the sash, wherein the hook arm assembly includes a base bracket with a first spindle, a hook arm pivotally attached to the first spindle and having a receiving hook at a second end, and a hook lock slidably mounted to the second end and biased away from the first spindle as the window is opened, and wherein the rivet pin assembly includes a mounting plate with a second spindle, a pivot arm pivotally attached to the second spindle, and a rivet pin attached to the pivot arm. This integrated window assembly provides comprehensive safety control by limiting window opening while maintaining emergency egress capability.

According to one example, the hook arm assembly is coupled to the window frame and the rivet pin assembly is coupled to the window sash. This specific mounting configuration optimizes the mechanical advantage and engagement geometry for reliable operation across the window's opening range.

According to another example, the hook arm and pivot arm are each biased by respective springs to facilitate automatic engagement when the window reaches a predetermined opening position. This dual spring system ensures reliable automatic engagement without requiring user intervention, providing consistent safety protection.

According to another example, the mounting plate has a rail and the hook lock slides along the rail as the window is opened. This sliding mechanism enables smooth operation and proper positioning of the hook lock throughout the window's opening cycle.

According to another example, the hook arm is biased to extend towards the rivet pin assembly such that the hook lock slides on the rail as the window is opened. This biasing action ensures the hook lock maintains proper contact with the rail and positions itself for reliable engagement with the rivet pin.

According to another example, the pivot arm is biased to rotate such that the rivet pin moves in a direction towards the hook arm as the window is opened. This coordinated movement ensures optimal positioning of both components for reliable engagement when the predetermined opening distance is reached.

According to another example, the hook arm assembly and rivet pin assembly limit the sash opening to approximately four inches in an initial operation. This specific limitation complies with Consumer Product Safety Commission recommendations for preventing children from falling through open windows while still allowing adequate ventilation.

A method is also described below for controlling window opening. The method comprises providing a hook arm assembly on one of a window frame or sash, providing a rivet pin assembly on the other of the window frame or sash, biasing a hook arm of the hook arm assembly towards the sash such that a receiving hook automatically engages a rivet pin of the rivet pin assembly when the window reaches a predetermined opening position, and securing the engagement with a hook lock that slides to lock the receiving hook onto the rivet pin. This method provides automatic safety control that requires no user intervention while maintaining the ability for deliberate override when necessary.

According to another example, the method further comprises enabling disengagement by requiring two manual actions: sliding the hook lock away from a first spindle and pivoting the hook arm away from the rivet pin. This two-step disengagement process provides child-resistant safety while allowing adults to override the mechanism for emergency egress or full window opening when needed.

### BRIEF DESCRIPTION OF THE DRAWINGS

FIG. 1A shows a casement window with an installed window opening control device hardware.

FIG. 1B shows a detailed view of the window opening control device components mounted on the window.

FIG. 2A shows a top view of a hook arm assembly and a rivet pin assembly.

FIG. 2B shows a bottom view of the hook arm assembly and rivet pin assembly.

FIG. 2C shows a side view of the hook arm assembly and rivet pin assembly.

FIG. 3A shows the hook arm assembly mounted to the sash.

FIG. 3B shows a section view of the hook arm with contained springs.

FIG. 4A shows the rivet pin assembly mounted on the sash in free position.

FIG. 4B shows a pivoting arm with the rivet pin.

FIG. 4C shows base design with pivoting spring.

FIG. 4D shows the pivoting rivet pin assembly in full compressed position.

FIG. 5A shows hook arm and rivet pin assemblies prior to engagement with a sash opening greater than 4 inches.

FIG. 5B shows both assemblies post engagement with a sash opening to the limited distance.

FIG. 5C shows both assemblies post engagement with a sash opening to the limited distance.

FIG. 5D shows both assemblies post engagement with a sash opening to the limited distance.

FIG. 5E shows section view through frame of both assemblies when a sash is fully closed

FIG. 5F shows hook arm assembly and rivet pin assembly re-engaged to the maximum 4 inch opening.

FIG. 6 shows the two actions to operate and release the hardware where the hook feature slides and the hook arm is pulled back towards the user.

### DETAILED DESCRIPTION

In the following detailed description, reference is made to the accompanying drawings illustrating examples in which the disclosure may be practiced. It should be understood that other examples may be utilized and changes may be made without departing from the scope of the present disclosure. The drawings and detailed description are not intended to limit the disclosure to the particular form disclosed. On the contrary, the intention is to cover all modifications, equivalents, and alternatives falling within the spirit and scope of the present disclosure.

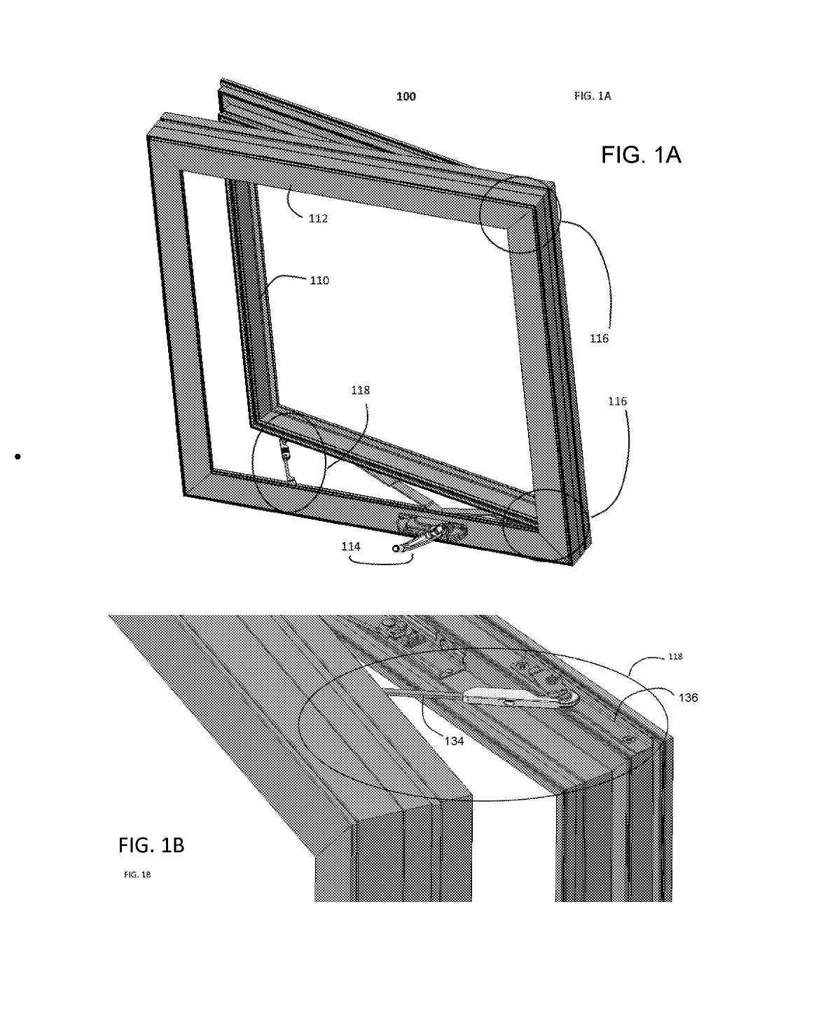

Referring to FIGS. 1A and 1B, the window opening control device 118 comprises a hook arm assembly 134 and a rivet pin assembly 136. The device is integrated into a window 100, which includes a window sash 110 and a window frame 112. The window sash 110 is mounted to the frame 112 via one or more hinge mechanisms 116, allowing the sash 110 to pivot outwardly or inwardly, depending on the window type. The window operates smoothly through a crank handle or lever mechanism 114, generally located adjacent the hinged side, which controls the gear mechanism that opens or closes the window. The rivet pin assembly 136 is securely mounted to the window sash 110, preferably against the bottom corner surfaces of the sash 110, depending on the orientation of the window.

It is noted that in the examples illustrated in this disclosure, the hook arm assembly 134 is mounted on the frame 112 and the rivet pin assembly 136 is mounted on the sash 110. It should be clear to those of ordinary skill in the art that in other example implementations, the hook arm assembly 134 may be mounted on the sash 110 and the rivet pin assembly 136 may be mounted on the frame 112.

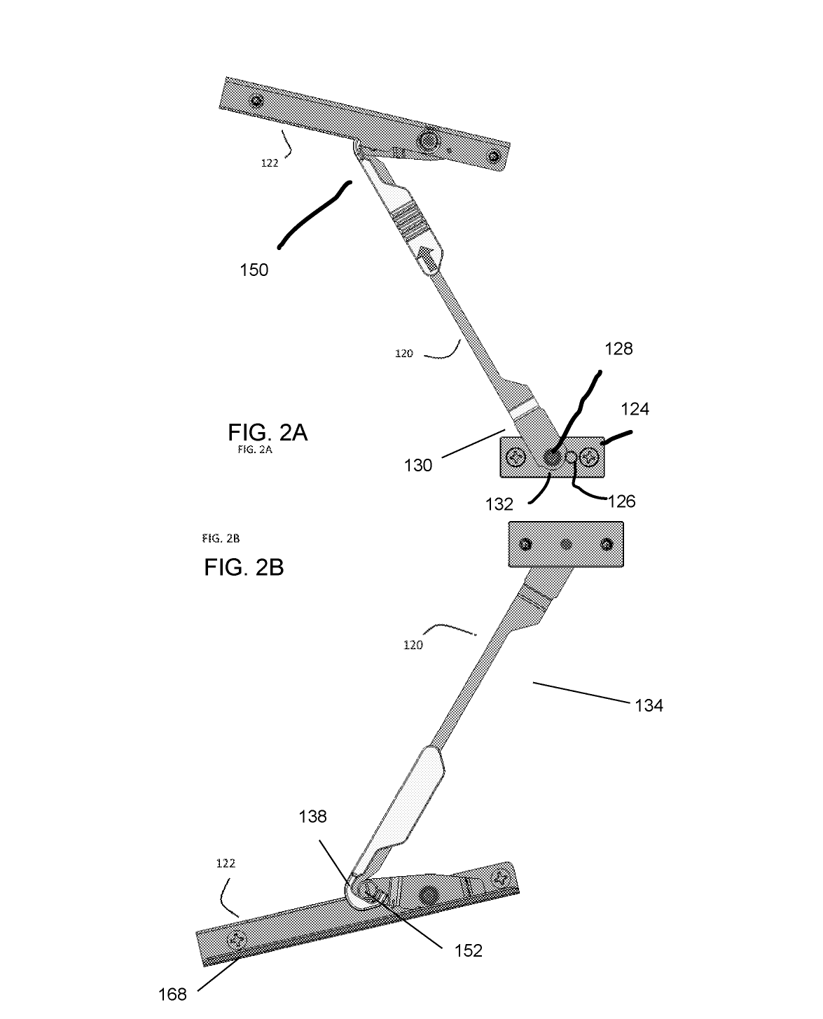

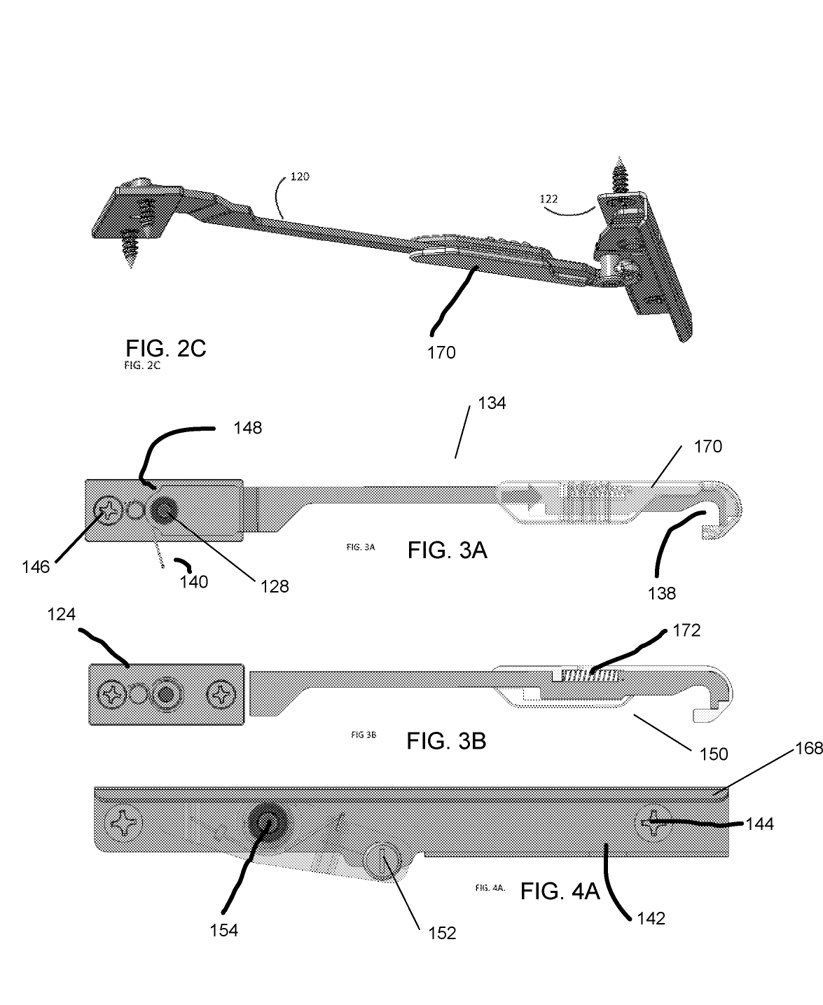

Referring to FIGS. 2A, 2B and 2C, the hook arm assembly 134 includes a first spindle 128 projecting from a front face of the base bracket 124. A hole through a first portion 132 of the hook arm 120, proximate the first end 130, is sized to receive the spindle 128 so that the hook arm 120 may be rotatably attached to the frame 112. A limiting pin 126 on base bracket 124 engages in cutouts 148 on the first end 130 of hook arm 120 to prevent the arm from rotating beyond desired limits. A receiving hook 138 on the second end 150 of the hook arm 120 is sized to receive a rivet pin 152. The hook arm 120 is biased, for example by a hook arm spring 140, to a desired position so that when the window is opened the second end 150 of the hook arm 120 is biased away from the frame 112 towards the sash 110. The length of the hook arm 120 determines how far the sash 110 can be opened from the closed position. The rivet pin assembly 136 includes a rivet pin 152 biased a desired distance from rail 168 of pivot pin base 122. The base bracket 124 may be fixed to the frame 112 with screws 146 or similar fixing means.

It is noted that in alternative embodiments, the hook arm 120 may be biased using torsion, compression and extension springs, as well as stretchable return members such as for example, plastic shims, o-rings, or elastic bands configured to bias the hook arm towards the open window. Attracting or opposing magnets may also be used to rotationally bias the hook arm 120 towards the open window.

Referring to FIGS. 3A and 3B, the hook arm assembly 134 includes a hook lock 170. The hook lock 170 is movably adapted to fit over at least the second end 150 of the hook arm 120 and the receiving hook 138. The hook lock 170 is biased away from the first spindle 128 as the window opens by one or more hook lock springs 172 or other biasing members. Other biasing members may include, for example, torsion, compression and extension springs, as well as stretchable return members such as for example, plastic shims, o-rings, or elastic bands configured to bias the hook lock away from the first spindle 128.

The hook lock 170 is shaped to engage the rivet pin 152 as the sash is opened, the rivet pin 152 first engages with the receiving hook 138, causing the hook lock 170 to slide distally until the rivet pin 152 is set into the receiving hook 138 then the hook lock 170 slides proximally and locks the receiving hook 138 onto the rivet pin 152. The hook lock spring 172 biases the hook look towards the first spindle 128 and against outward motion of the rivet pin 152 once the hook lock 170 is engaged with the rivet pin 152. This secure engagement prevents the sash from being opened without first disengaging the hook lock 170 latch, thereby enhancing the security and reliability of the window. The receiving hook 138 is shaped to have a curved or angled receiving section that can securely latch onto the rivet pin 152 when the window is opened. The hook arm 120 is biased towards the sash 110 such that it slides along the rail 168 until it automatically engages the rivet pin 152 when the window reaches the predetermined opening position, thereby controlling the opened distance.

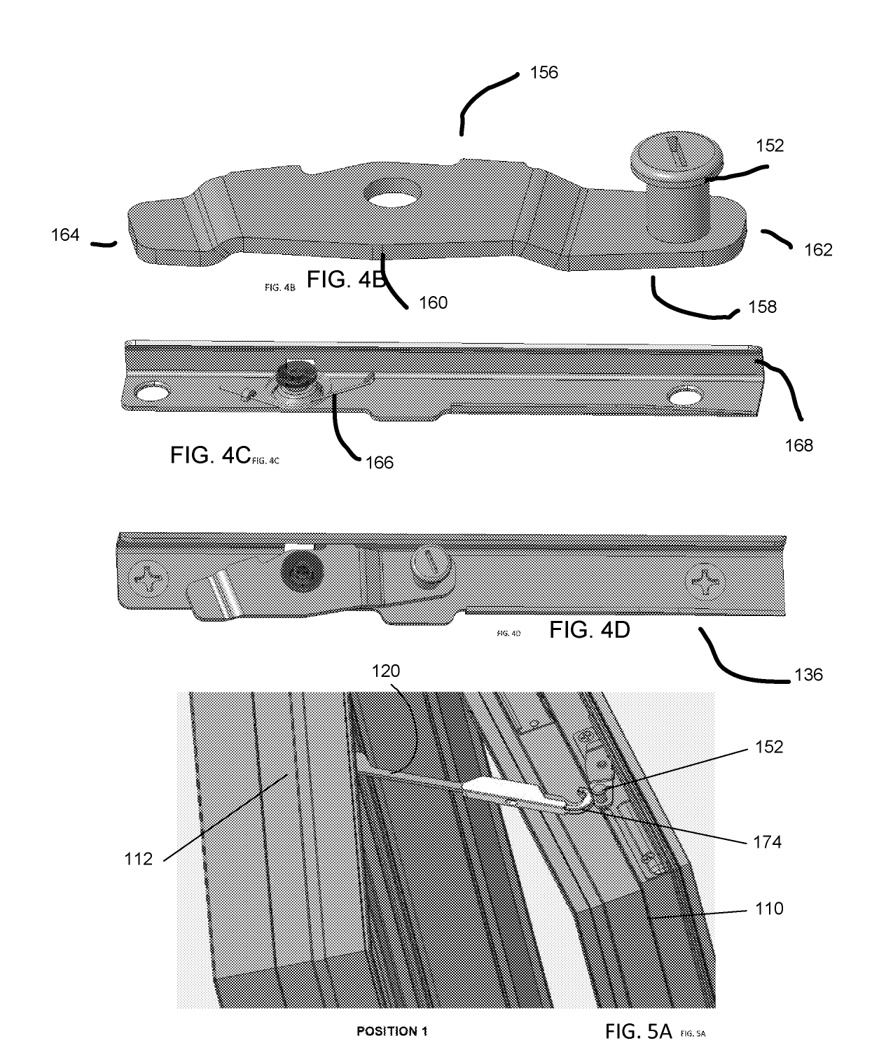

Referring to FIGS. 4A through 4D, the rivet pin assembly 136 includes a mounting plate 142 that may be fixed to the sash 110 with screws 144 or similar fixing means, a second spindle 154 projecting from a front face of the mounting plate 142, a pivot arm 156, and a rivet pin 152. The rivet pin 152 is on the first portion 158 of the pivot arm, and a hole through a raised portion 160 between the first end 162 and the second end 164, is sized to receive the second spindle 154 so that the pivot arm 156 may be rotatably attached to the sash 110. The pivot arm 156 is biased, for example by a pivot arm spring 166, to a desired position so that when the window 100 is opened the first portion 162 of the pivot arm 156 is biased towards the frame 112 away from the sash 110, or towards the rail 168 of the mounting plate 142. The second end 164 of the pivot arm 156 prevents the first end 162 from rotating beyond a desired distance such that the rivet pin 152 is at desirable distance from the sash 110. One skilled in the art will appreciate that the increased distance between the rivet pin 152, the sash 110, or rail 168 facilitates engagement of the rivet pin 152 and the receiving hook 138. The rivet pin 152 may be cylindrical and can be made from metal, plastic, or other durable materials capable of withstanding repeated use and environmental exposure.

It is noted that in alternative embodiments, the pivot arm 156 may be biased using torsion, compression and extension springs, as well as stretchable return members such as for example, plastic shims, o-rings, or elastic bands configured to bias the first end 162of the pivot arm 156 towards the open window. Attracting or opposing magnets may also be used to rotationally bias the pivot arm 156 towards the rail of the mounting plate 142.

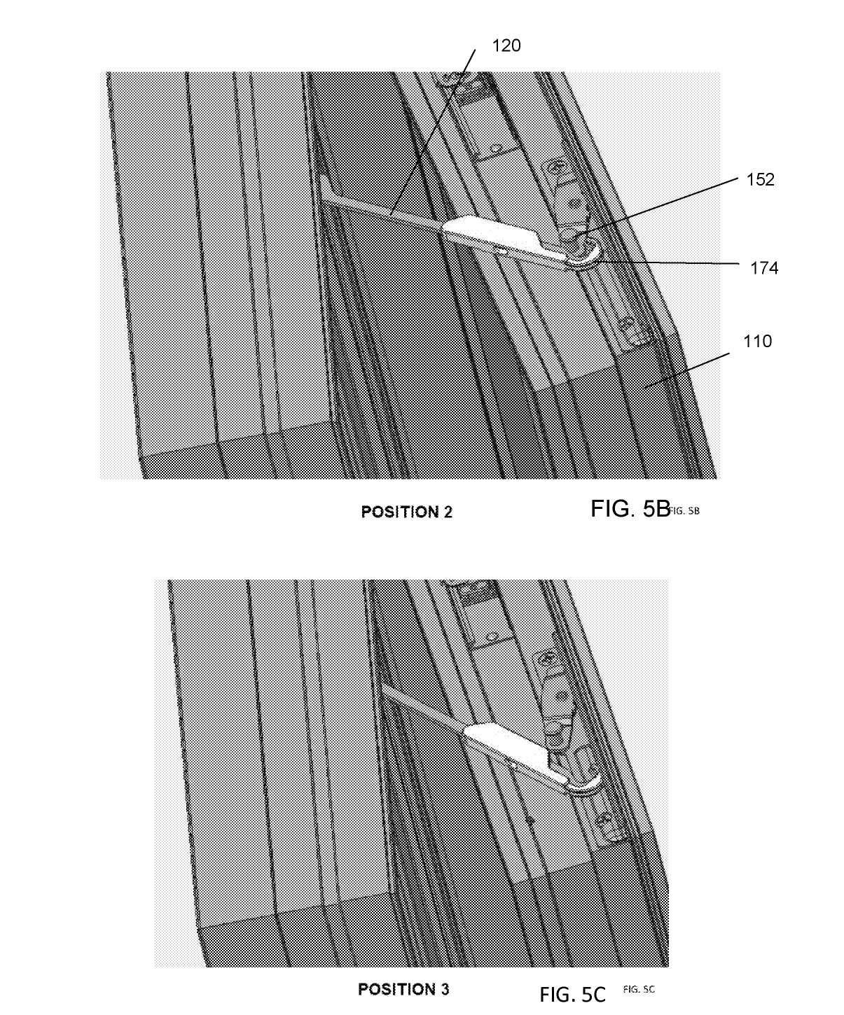

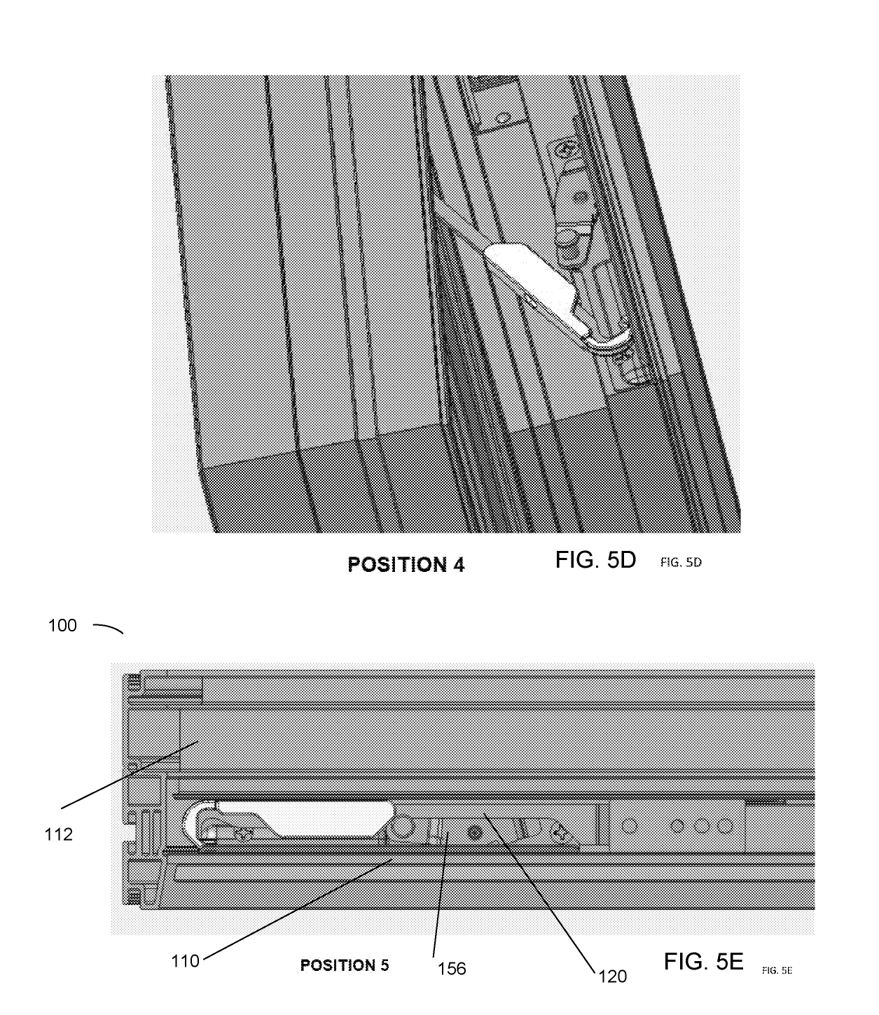

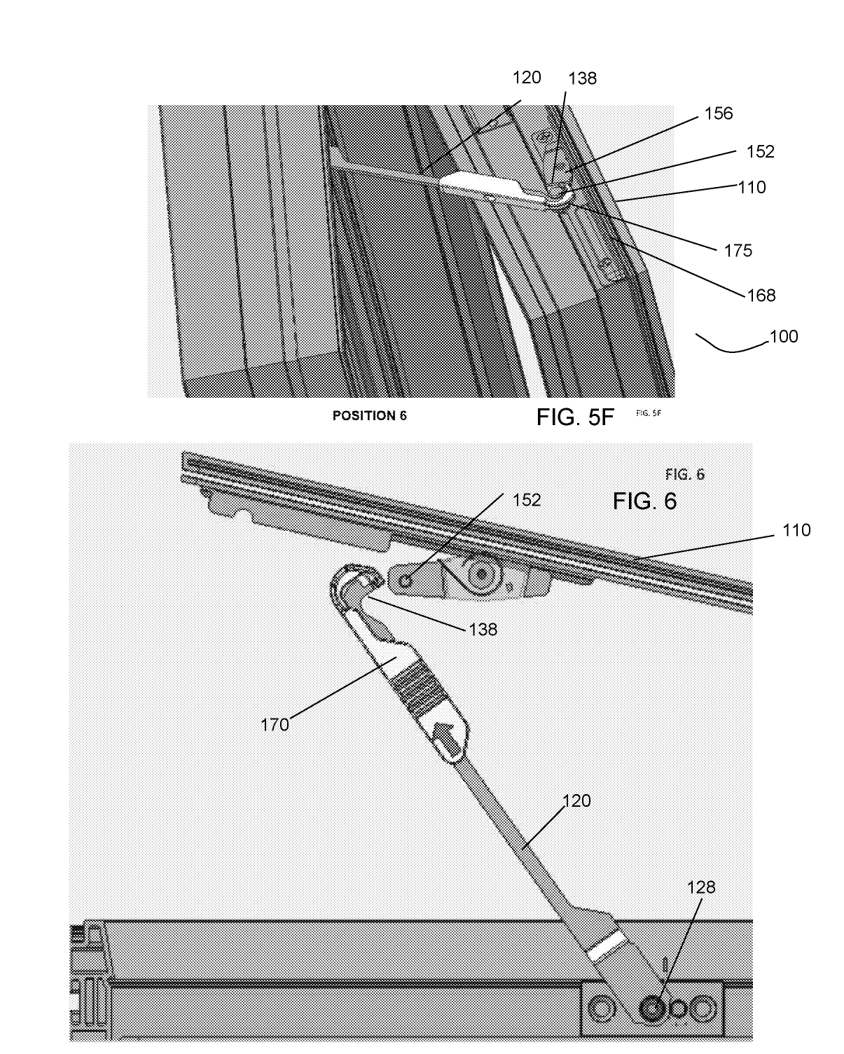

Referring to FIG. 5A the hook arm 120 is attached to the window frame 112 and is designed to engage with the rivet pin 152 at a specific point along the window's opening and closing paths. When the sash 110 is being closed after the window opening control device was disengaged, the hook member 120 is biased towards the sash 110 such that the hook outer curve 174 slides over the rivet pin 152 without engaging.

Referring to FIGS. 5B through 5D, as the sash 110 continues to close, the hook member 120 passes over rivet pin 152 and hook outer curve 174 slides along rail 168.

Referring to FIG. 5E, when window 100 is closed, hook arm 120 is generally flush against frame 112 and biases pivot arm 156 towards sash 110. Such biasing reduces the space necessary between frame 112 and sash 110 to accommodate the window opening control device 118.

Referring to FIG. 5F, as window 100 moves from closed to open position, the hook arm 120 is biased outward towards sash 110 such that hook outer curve 175 slides along rail 168 towards pivot arm 156. Pivot arm 156 also rotates such that rivet pin 152 moves a desired distance from sash 110. The increased distance between rivet pin 152 and sash 110 facilitates engagement of receiving hook 138 and rivet pin 152.

Referring to FIG. 6, the window opening control device 118 requires two manual actions to disengage. First, the user must slide hook lock 170 distally away from first spindle 128 towards sash 110 such that receiving hook 138 is not obstructed by hook lock 170. Second, while biasing hook lock 170 towards sash 110 hook arm 120 must be pivoted away from rivet pin 152.

To operate the window 100, the user simply pivots the sash 110 outwardly or inwardly, depending on the window type. As the sash 110 is moved, the hook arm 120 is biased outward by spring 140 toward sash 110. Also while the sash 110 is moved, pivot arm 156 is biased outward by spring 166 toward frame 112 such that the distance between rivet pin 152 and sash 110 increases to a desired distance. Hook lock 170 slides along rail 168 toward the rivet pin 152. When the window reaches the desired opening angle, the receiving hook 138 engages with the rivet pin 152 and hook lock 170 biases towards first spindle 128, locking the rivet pin 152 in the receiving hook 138. The engagement prevents the sash 110 from opening further, thereby restricting the window's movement to a safe and secure range.

To increase the distance between the sash 110 and the frame 112, the user can disengage the receiving hook 138 from the rivet pin 152 by pushing hook lock 170 distally from spindle 128. Once released, the window can be opened further or closed as desired.

In view of the biased hook arm 120 and pivot arm 156 the window opening control device 118 is engaged when opening and properly reengages upon closing of the sash after release. Also, operation of the release of the hook arm is intuitive, requiring only sliding a hook lock 170 distally outward while rotating the hook arm 120 away from the rivet pin 152 to effect release. This saves time and effort during operation. The present disclosure provides a casement window assembly that includes a window frame 112, a sash 110 pivotally mounted to the frame, a hook arm assembly 134, and a rivet pin assembly 136. The sash 110 may be pivotally mounted to a horizontal or vertical side of the frame 112. The hook arm 120 is designed to engage the rivet pin 152 when the sash is closed, and it is equipped with a sliding latch mechanism that automatically locks the hook arm 120 into engagement with the rivet pin 152.

The foregoing description of various examples has been presented for purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

1. A window opening control device for limiting the rotation of a sash movably mounted with a frame, the opening control device comprising:
a hook arm assembly for coupling to one of either the frame or the sash;
a rivet pin assembly for coupling to the other of the frame or the sash;
the hook arm assembly including a base bracket, a first spindle projecting from a front face of the base bracket, and a hook arm having a first end and a second end, the first end being pivotally attached to the first spindle and the second end having a receiving hook;
a hook lock slidably mounted to the second end of the hook arm, the hook lock biased away from the first spindle as the window is opened; and
the rivet pin assembly including a mounting plate having a second spindle projecting from a front face of the mounting plate, and a pivot arm pivotally attached to the second spindle, the pivot arm having a rivet pin attached to a first end.

2. The window opening control device of claim 1, wherein the hook arm is biased by a hook arm spring such that when the window is opened, the hook arm is rotatably biased towards the window opening.

3. The window opening control device of claim 1, wherein the base bracket includes a limiting pin that engages in cutouts on the first end of the hook arm to prevent the hook arm from rotating beyond desired limits.

4. The window opening control device of claim 1, wherein the hook lock is shaped to engage the rivet pin when the hook arm is under tension relative to the rivet pin.

5. The window opening control device of claim 2, wherein the hook lock is biased by a hook lock spring away from the first spindle as the window opens and towards the first spindle as the hook lock is pulled away from the first spindle.

6. The window opening control device of claim 1, wherein the receiving hook is shaped to have a curved or angled receiving section that securely latches onto the rivet pin when the window is opened.

7. The window opening control device of claim 1, wherein the mounting plate includes a rail positioned on the mounting plate opposite the window opening side of the mounting plate.

8. The window opening control device of claim 1, wherein the pivot arm is biased by a pivot arm spring such that when the window is opened, the first end of the pivot arm is biased to rotate towards the window opening.

9. The window opening control device of claim 7, wherein the pivot arm includes a second end configured to contact the rail to prevent rotation of the first end beyond a desired distance such that the rivet pin is positioned at a desirable distance from the sash.

10. The window opening control device of claim 1, wherein the rivet pin is cylindrical and made from a material selected from the group consisting of metal, plastic, and other durable materials capable of withstanding repeated use and environmental exposure.

11. The window opening control device of claim 1, wherein the hook arm assembly and rivet pin assembly are configured such that disengagement requires two manual actions: sliding the hook lock distally away from the first spindle and pivoting the hook arm away from the rivet pin.

12. A window assembly comprising:
a window frame;
a sash pivotally mounted to the frame via one or more hinge mechanisms configured to enable a window opening;
a hook arm assembly coupled to either the frame or the sash;
a rivet pin assembly coupled to the other of the frame or the sash;
wherein the hook arm assembly includes a base bracket with a first spindle, a hook arm pivotally attached to the first spindle and having a receiving hook at a second end, and a hook lock slidably mounted to the second end and biased away from the first spindle as the window is opened; and
wherein the rivet pin assembly includes a mounting plate with a second spindle, a pivot arm pivotally attached to the second spindle, and a rivet pin attached to the pivot arm.

13. The window assembly of claim 12, wherein the hook arm assembly is coupled to the window frame and the rivet pin assembly is coupled to the window sash.

14. The window assembly of claim 12, wherein the hook arm and pivot arm are each biased by respective springs to facilitate automatic engagement when the window reaches a predetermined opening position.

15. The window assembly of claim 14, wherein the mounting plate has a rail and the hook lock slides along the rail as the window is opened.

16. The window assembly of claim 15, wherein the hook arm is biased to extend towards the rivet pin assembly such that the hook lock slides on the rail as the window is opened.

17. The window assembly of claim 14, wherein the pivot arm is biased to rotate such that the rivet pin moves in a direction towards the hook arm as the window is opened.

18. The window assembly of claim 12, wherein the hook arm assembly and rivet pin assembly limit the sash opening to approximately four inches in an initial operation.

19. A method of controlling window opening comprising:
providing a hook arm assembly on one of a window frame or sash;
providing a rivet pin assembly on the other of the window frame or sash;
biasing a hook arm of the hook arm assembly towards the sash such that a receiving hook automatically engages a rivet pin of the rivet pin assembly when the window reaches a predetermined opening position; and
securing the engagement with a hook lock that slides to lock the receiving hook onto the rivet pin.

20. The method of claim 19, further comprising enabling disengagement by requiring two manual actions: sliding the hook lock away from a first spindle and pivoting the hook arm away from the rivet pin.
